(19) United States
(12) Patent Application Publication
(10) Pub. No.: US 2025/0291322 A1
(43) Pub. Date: Sep. 18, 2025

(54) DETECTION OF UNAUTHORIZED ACTIVITIES IN INDUSTRIAL CONTROL SYSTEMS

(71) Applicant: Honeywell International Inc., Charlotte, NC (US)

(72) Inventors: Atul Bassi, Bangalore (IN); Anubhav Misra, Bangalore (IN); Tarun Gupta, Bangalore (IN)

(21) Appl. No.: 18/948,564

(22) Filed: Nov. 15, 2024

(30) Foreign Application Priority Data
Mar. 14, 2024 (IN) 202411018730

(51) Int. Cl. G05B 13/02

(52) U.S. Cl. CPC G05B 13/0265

(57) ABSTRACT

Approaches for classifying processes implemented and executing within an industrial control system based on operational data, are described. In one example, actual operational data (obtained in real-time or in batches) of an operational component may be obtained. The operational component may be deployed in any of multiple architectural levels of an industrial control system. In an example, the actual operational data may comprise actual operating parameters corresponding to a target activity. Based on the actual operational data, a machine learning model may be trained to determine whether the target activity is a valid activity. The machine learning model may be trained based on training data comprising a set of training operating parameters pertaining to a plurality of valid activities occurring in an untampered process, executing within the industrial control system.

### BACKGROUND

Industrial processes, such as manufacturing, product handling, production, distribution, and such, may involve managing and streamlining operation of a variety of equipment or systems, such as pumps, valves, vessels, filters, coolers, and piping. To ensure that the industrial processes operate in a performant manner, industrial control systems may be used to control such industrial processes. The industrial control systems include supervisory, control and data acquisition systems which monitor and/or control geographically dispersed assets, distributed control systems or smaller control systems using programmable logic to control such processes. With rise in digitalization through electronics and computing systems, industrial control systems have become automated to enable data-driven decision-making and remote management.

### BRIEF DESCRIPTION OF FIGURES

Systems and/or methods, in accordance with examples of the present subject matter are now described and with reference to the accompanying figures, in which:

FIG. 1 illustrates a system for detection of an unauthorized activity in an industrial control system, as per an example;

FIG. 2 illustrates a training system for training a machine learning model for training a detection model to detect an unauthorized activity in an industrial control system, as per an example;

FIG. 3 illustrates an environment related to processes implemented and executing within an industrial control system, as per another example;

FIG. 4 illustrates components of a networked environment implementing a system for detection of an unauthorized activity, as per an example;

FIG. 5 illustrates a system for detection of an unauthorized activity in an industrial control system, as per an example;

FIG. 6 illustrates an example interface for detection of an unauthorized activity in an industrial control system, as per another example;

FIG. 7 illustrates a method for training a machine learning model for classifying processes implemented and executing within an industrial control system, as per an example;

FIG. 8 illustrate a method for detection of an unauthorized activity in an industrial control system, as per an example; and

FIG. 9 illustrates a system environment implementing a non-transitory computer readable medium for detection of an unauthorized activity in an industrial control system, as per an example.

### DETAILED DESCRIPTION

Generally, industrial processes being implemented using industrial control systems (ICS) may involve monitoring, managing, and streamlining operations of a variety of systems in one or more facilities of an enterprise. An ICS may comprise two physical networks—an operational technology (OT) network, also referred to as a process control network (PCN) and an information technology (IT) network or a business network (BN). The OT network includes programmable control systems and/or devices that may interact with physical environments or may manage devices that interact with the physical environments. Such systems/devices detect or cause a direct change through the monitoring and/or control of devices, processes, and events. The control systems in turn may further include a collection of devices, systems, networks, and controls. Within the OT network is where most of the Distributed Control Systems (DCS), programmable logic controllers (PLCs), and/or field devices may be deployed.

For example, the ICS comprises numerous control loops, human interfaces, and remote diagnostics and maintenance tools built using an array of network protocols on layered network architectures. A control loop utilizes sensors, actuators, and controllers to manipulate controlled processes. A sensor is a device that produces measurement of any physical properties and sends information to the controllers. The controller interprets the signals and generates corresponding manipulated variables, based on set points, which are then transmitted to the actuators. The actuators, such as control valves, breakers, switches, and motors, are used to directly manipulate the controlled processes based on commands from the controllers. Operators and/or engineers may use human interfaces to monitor and configure set points, control algorithms, and adjust and establish parameters in the controllers. The human interfaces may also display process status information and historical information. The control loops may be nested and/or cascading wherein the set point for one loop is based on the process variable determined by another loop.

Nowadays, OT systems have become linked to IT systems to monitor and adjust OT systems for remote management. The convergence of OT and IT has given networking capabilities to ICSs, enabling cost savings and flexibility in remote management and monitoring of industrial processes with the use of cyber components. For example, with reference to the Purdue model, elements of the layered network in the ICS architecture are interconnected into six zones containing both IT and OT systems, divided into various layers and stages of an architectural life cycle in the enterprise. The Purdue model provides a framework for segmenting OT networks from the IT networks. The OT systems generally occupy lower levels in the Purdue model, while IT systems occupy the upper levels, with a demilitarized zone of convergence between them.

Continuing further, a plurality of systems and/or devices of the ICS operate across multiple architectural levels of an enterprise. The operation of such control systems and/or devices (collectively referred to as operational components) in turn may be depicted through their corresponding operational data. The operational data may be monitored to ascertain whether the operational components continue to operate in a performant manner. To this end, one or more predefined rules may be configured for such operational components. When the operational data exceeds thresholds prescribed in the predefined rules, one or more alerts may be generated, and further actions may be required for addressing the conditions that may have resulted in the generation of such alerts. It may be noted that the conditions as described above may result owing to processes or functioning of the operational components without any manipulations.

Generally, OT networks are prone to cybersecurity threats due to increased connectedness with the IT networks. Within the facilities of the enterprise, the operation of the various systems may be monitored through alarms and events, wherein systems may be deployed to monitor various events pertaining to different industrial processes. Any deviation from an otherwise performant operation or well-defined operational limits is detected, and accordingly notified to the concerned personnel as a visual or an aural indication. The concerned personnel may then take necessary actions to prevent or mitigate potential consequences that may follow as a result of the deviation.

In certain situations, the conditions that may lead to generation of alerts may also arise owing to an unauthorized tampering or manipulations that may be brought about by an unauthorized or malafide individual who may have gained access of the OT network. In such cases, the individual may affect one or more changes (e.g., in configuration settings, or such) to the processes implemented within the industrial control systems, eventually causing unfavourable operating conditions of the operational components within the OT network, thereby triggering alerts. Examples of such unfavourable conditions include, but are not limited to, ceasing of the execution of one or more processes, etc. These may be a result of malicious attackers exploiting vulnerabilities within the industrial control system wherein which the attackers may manipulate operating parameter(s), alter setpoint(s), or disable safety mechanism(s), which may lead to equipment malfunction, product quality issues, or even dangerous operating conditions. Also, malicious attackers may encrypt essential data or lock-out operators from control interface(s), tamper sensor data or control signals, effectively halting production lines, and leading to incorrect decisions by automated systems or human operators. Additionally, such cybersecurity threat(s) may also compromise personnel safety.

Although useful in detecting the occurrence of such unfavourable conditions, alerts or predefined rules may not be sufficient for detecting the unauthorized tampering of processes implemented within the industrial control systems. As a result, any such tampering may only be realized on the onset of one or more unfavourable conditions. Although predefined rules may be implemented to assess any or all changes occurring at all stages, but such rules may also fail to differentiate any issues that may generally arise due to faulty devices or issues that may occur in an untampered process. Alternatively, various indicators of attack(s) or threats, such as memory leak, high processor usage, etc., may also be mistaken for usual operating conditions due to complexities involved within the industrial control systems. Neither are such systems capable of detecting or addressing any zero-day vulnerabilities within newly implemented industrial control systems.

Approaches for detection of unauthorized activities in operational technology networks of industrial control systems, are described. In one example, the approaches comprise classifying processes implemented and executing within the industrial control systems based on operational data. In one example, actual operational data (obtained in real-time or in batches) of an operational component may be obtained. The operational component may be deployed in any of multiple architectural levels of an industrial control system. The operational component may comprise, for example, a sensor, actuator, controller, terminal units, programmable logic controllers (PLCs), distributed control systems (DCS), security system, machine interfaces, or combination thereof.

In an example, the actual operational data may comprise actual operating parameters corresponding to a target activity. For example, the actual operating parameters may be obtained from sources comprising user activity logs, network traffic logs, security management logs, change management logs, event and alarm histories, maintenance logs, or combinations thereof. The target activity may be performed in relation to a target process being executed within the industrial control system. Based on the actual operational data, a machine learning model may be trained to determine whether the target activity is a valid activity. The machine learning model may be trained based on training data comprising a set of training operating parameters pertaining to a plurality of valid activities occurring in an untampered process, executing within the industrial control system. Accordingly, an indication may be generated to depict that the target activity is one of a valid activity or an unauthorized activity, in response to the determination using the machine learning model.

For training the machine learning model, training data may be retrieved. The training data may pertain to a plurality of operational components operating across multiple architectural levels within an operational technology network of an industrial control system. In one example, the training data may comprise of a set of training operating parameters corresponding to a plurality of valid activities and unauthorized activities to have occurred in a process executing within the industrial control system. Based on the same, the machine learning model may be trained to categorize a target activity performed in relation to a target process as one of a valid activity and unauthorized activity, based on an actual operational data pertaining to the target activity.

Herein, the target activity and the target process correspond to all activities and processes being executed in the operational technology network of the industrial control system. The trained machine learning model may also be used to prepare for zero-day vulnerability attacks within the OT network. For example, based on a type of the operational component to which the target activity corresponds, a criticality factor may be associated with the type of the operational component. In one example, the criticality factor may refer to a measure indicating relative importance or a potential impact of the one or more operational components, operating within the OT networks. Accordingly, a risk factor may be annotated to the target activity, indicative of an impact caused by failure of the operational component. In one example, the risk factor may be a characteristic, a condition, or behaviour that may increase the potential impact of the one or more operational components operating within the OT networks. Further, a set of prescribed remedial measures may then be executed to implement an appropriate remedial measure in response to detecting an unauthorized activity.

The present subject matter provides numerous technical advantages in addressing the technical problem of detecting and mitigating unauthorized tampering and cybersecurity threats in OT networks. For example, the systems and methods disclosed herein combine real-time monitoring and machine learning algorithms for differentiating between normal operational issues and malicious activities, thereby, reducing false positives and enabling faster, and accurate threat detection. Also, the systems and method disclosed herein may be able to analyse patterns across multiple data points and timeframes for identifying subtle anomalies indicative of a malicious event, prior to the predefined thresholds being breached. Such an approach may enable an early intervention, potentially preventing serious consequences to industrial processes and equipment within the OT networks.

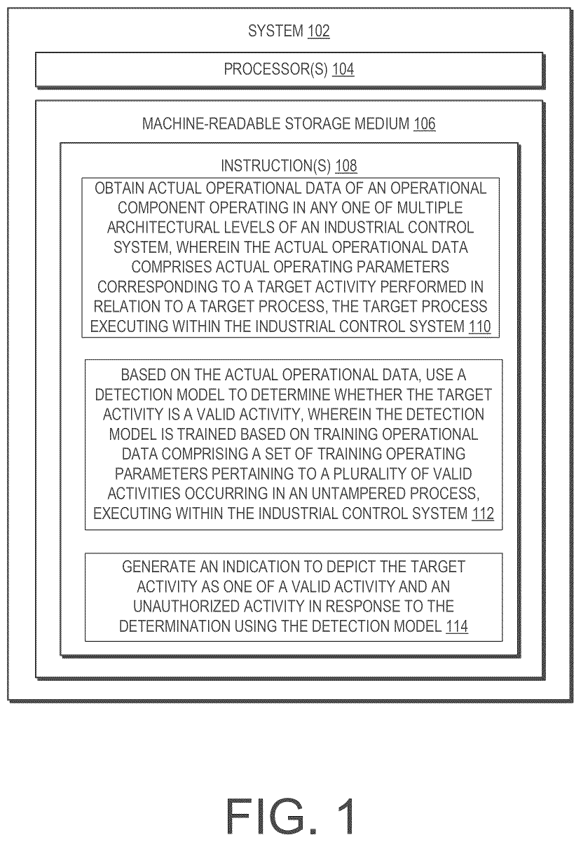

FIG. 1 illustrates system 102 for detection of an unauthorized activity in an industrial control system, as per one example. The detection of an unauthorized activity is based on one or more operating parameters observed for one or more operational components over a period of time, in accordance with an example of the present subject matter. The one or more operating parameters may reflect the operational history or current conditions of the one or more operational components. The system 102 includes a processor 104, and a machine-readable storage medium 106 which is coupled to, and accessible by, the processor 104. The system 102 may be implemented in any computing system, such as a storage array, server, desktop or a laptop computing device, a distributed computing system, or the like. Although not depicted, the system 102 may include other components, such as interfaces to communicate over the network or with external storage or computing devices, display, input/output interfaces, operating systems, applications, data, and the like, which have not been described for brevity.

The processor 104 may be implemented as a dedicated processor, a shared processor, or a plurality of individual processors, some of which may be shared. The machine-readable storage medium 106 may be communicatively connected to the processor 104. Among other capabilities, the processor 104 may fetch and execute computer-readable instructions, including instructions 108, stored in the machine-readable storage medium 106. The machine-readable storage medium 106 may include non-transitory computer-readable medium including, for example, volatile memory such as RAM (Random Access Memory), or non-volatile memory such as EPROM (Erasable Programmable Read Only Memory), flash memory, and the like. The instructions 108 may be executed to classify the hardware components of the computing device.

In an example, the processor 104 may fetch and execute instructions 108. In one example, as a result of the execution of the instructions 110, the system 102 may obtain actual operational data of an operational component operating in any one of multiple architectural levels of an industrial control system. Herein, the actual operational data may comprise actual operating parameters corresponding to a target activity. The actual operating parameters may be obtained from sources comprising user activity logs, network traffic logs, security management logs, change management logs, event and alarm histories, and maintenance logs, pertaining to one or more operational components operating in the multiple architectural levels of the industrial control system.

Further, the target activity may be performed in relation to a target process, executing within the industrial control system. In one example, the operational component may be a control system, or a device deployed within one of the multiple architectural levels of the industrial control system. The operational components operate within an operational technology network of the industrial control system. The values of these operating parameters may be obtained directly from sensors on the operational components or from an intermediate data storage system where such information is collected and stored.

Once obtained, the instructions 112 may be executed to determine whether the target activity is a valid activity, using a detection model. The determination of whether the target activity is a valid activity is based on the trained detection model. In one example, the detection model is trained based on training data comprising a set of training operating parameters. The training operating parameters may pertain to a plurality of valid activities occurring in an untampered process, executing within the industrial control system. Once the determination is made on whether the target activity is a valid activity, the instructions 114 may be executed to generate an indication to depict the target activity is one of a valid activity and an unauthorized activity, in response to the determination using the detection model.

The above functionalities performed as a result of the execution of instructions 108, may be performed by different programmable entities. Such programmable entities may be implemented through neural network-based computing systems, which may be implemented either on a single computing device, or multiple computing devices. As will be explained, various examples of the present subject matter are described in the context of a computing system for training a neural network-based model, and thereafter, utilizing the neural network model for estimating value of performance indicator by using actual operational metrics of the asset based on the estimation model. These and other examples are further described with respect to other figures.

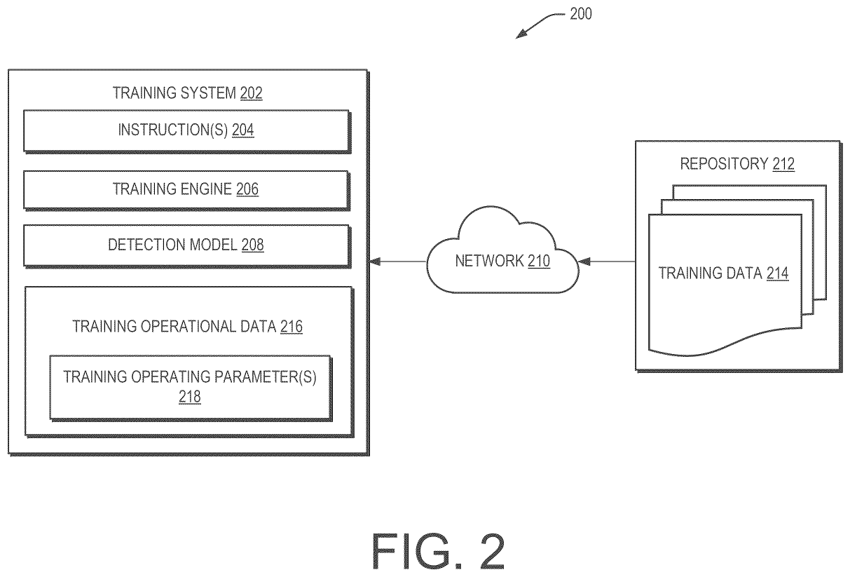

FIG. 2 illustrates an environment 200 of a training system 202 comprising a processor or memory (not shown), for training a detection model to detect an unauthorized activity in an industrial control system. In an example, the training system 202 (referred to as system 202) may be communicatively coupled to a repository 212 through a network 210. The repository 212 may further include training data 214. The training data 214 may pertain to data about a plurality of operational components operating across multiple architectural levels within an industrial control system.

The training data 214, although depicted as being obtained from a single repository, such as repository 212, may also be obtained from multiple other sources without deviating from the scope of the present subject matter. In such cases, each of such multiple repositories may be interconnected through a network, such as the network 210.

The network 210 may be a private network or a public network and may be implemented as a wired network, a wireless network, or a combination of a wired and wireless network. The network 210 may also include a collection of individual networks, interconnected with each other and functioning as a single large network, such as the Internet. Examples of such individual networks include, but are not limited to, Global System for Mobile Communications (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN).

The system may further include instructions 204 and a training engine 206. In an example, the instructions 204 are fetched from a memory and executed by a processor included within the system 202. The training engine 206 may be implemented as a combination of hardware and programming, for example, programmable instructions to implement a variety of functionalities. In examples described herein, such combinations of hardware and programming may be implemented in several different ways. For example, the programming for the training engine 206 may be executable instructions, such as instructions 204. Such instructions may be stored on a non-transitory machine-readable storage medium which may be coupled either directly with the system 202 or indirectly (for example, through networked means). In an example, the training engine 206 may include a processing resource, for example, either a single processor or a combination of multiple processors, to execute such instructions. In the present examples, the non-transitory machine-readable storage medium may store instructions, such as instructions 204, that when executed by the processing resource, implement the training engine 206. In other examples, the training engine 206 may be implemented as electronic circuitry.

The instructions 204 when executed by the processing resource, cause the training engine 206 to train an artificial intelligence-based machine learning model such as a detection model 208. In an example, the detection model 208 is trained based on training data pertaining to a plurality of operating parameters. In one example, the plurality of operating parameters pertains to a plurality of operational components operating across multiple architectural levels within an industrial control system. The instructions 204 may be executed by the processing resource for training the detection model 208 based on the training data 214. In one example, the training data 214 may correspond to training operational data 216. In an example, the system 202 may obtain the training data 214 at one time, or in batches, from the repository 212.

In operation, the system 202 may obtain the training data 214 from the repository 212, and the data included in the training data 214 may further be stored as training operational data 216. In an example, the training operational data 216 comprises a set of training operating parameter(s) 218. The training operating parameters 218 may correspond to a plurality of valid activities and unauthorized activities to have occurred in a process executing within the industrial control system. The training operational data 216 may comprise, but is not limited to, information pertaining to different loading stages, peak loads experienced, one or more failure observed during operation, performant operation, or combination therefore, of the plurality of operational components. In one example, the training operational data 216 may be obtained from, but are not limited to, user activity logs, network traffic logs, security management logs, change management logs, event and alarm histories, maintenance logs, or combinations thereof. The detection model 208 may be trained to categorize a target activity performed in relation to a target process as one of a valid activity and unauthorized activity. The determination of the target activity regarding whether the target activity is a valid activity, or an unauthorized activity may be based on an actual operational data pertaining to the target activity. In one example, the detection model 208 may also be trained based on additional operating parameter(s) received from an administrator.

The detection model 208 may be trained over a period of time. For instance, actual operational data of the plurality of operational components may be continuously monitored to ascertain whether the operational component(s) continue to operate in a performant manner. The detection model 208 when trained, may be used to indicate when the operational data exceeds a threshold value prescribed in predefined rules configured for the plurality of operational components. An alert may be generated, and further actions may be required for addressing the conditions that may have resulted in generation of such alerts. Herein, the target activity and the target process may correspond to all activities and processes being executed within the industrial control system.

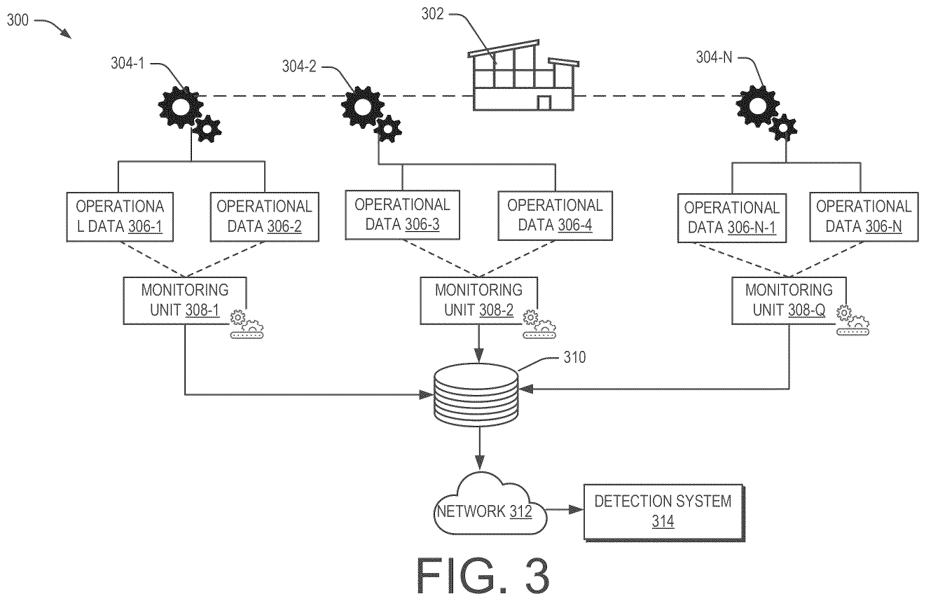

The detection model 208, through continuous training on the training operational data 216, when implemented (e.g., in a detection system, as described in conjunction with FIG. 3), is to monitor and assess normal operational variations and identify instances of potential security threats, thereby providing a robust, proactive defence, e.g., against evolving cybersecurity risks in industrial control systems.

FIG. 3 illustrates a networked industrial environment 300 (referred to as environment 300) of an industrial control system 302. The industrial control system may be associated with a detection system, such as a detection system 314 used for detecting an unauthorized activity, in response to a set of operating parameters observed in relation to operational components present within the environment 300 over a period of time.

The environment 300 further include a plurality of operational components 304-1, 304-2, . . . , 304-N (collectively referred to as component(s) 304 installed and operating within the industrial control system 302. These component(s) 304 may include various types of control systems, devices, or their respective combinations. For example, the control systems may be related to industrial equipment such as chemical processing unit, petrochemical processing unit, refining unit, oil and gas production unit, power generation unit, manufacturing unit, material handling unit, water treatment unit, food processing unit, unit, water treatment unit, food processing unit, pharmaceutical production unit, paper processing unit, metallurgical processing unit, mining and mineral processing unit, textile processing units, electronics manufacturing unit, automotive manufacturing units, aerospace manufacturing unit, waste management unit, renewable energy production unit, agricultural processing unit, and biotechnology processing unit. Specific examples may include continuous catalytic reforming (CCR) units, distillation columns, fluid catalytic cracking (FCC) units, hydrotreating units, steam crackers, polymerization reactors, boilers, compressor stations, heat exchanger networks, cooling towers, electrolysis cells, absorption towers, crystallization units, fermentation tanks, extruders, and filtration units.

On the other hand, the devices may include user device(s), actuators, monitors, peripherals, interfaces, servers, etc., operating in the environment 300 of the industrial control system 302. Each of these component(s) 304 (which may be control systems or devices) may have multiple operating parameters. The multiple operating parameters of the component(s) 304 may be retrieved as operational data 306-1, 306-2, . . . , 306-N (collectively referred as operational data 306), and may further be monitored by a plurality of monitoring units 308-1, 308-2, . . . 308-Q (collectively referred as monitoring unit(s) 308) and adjusted to optimize performance. The operational data 306 may be continuously stored in the repository 310. The operational data 306 stored in the repository 310 may be processed by a detection system 314, using the trained detection model, such as the trained detection model 208.

The detection system 314 may be communicatively coupled with the environment 300 over the network 312. The network 312 may be a private network or a public network and may be implemented as a wired network, a wireless network, or a combination of a wired and wireless network. The network 312 may also include a collection of individual networks, interconnected with each other and functioning as a single large network, such as the Internet. Examples of such individual networks include, but are not limited to, Global System for Mobile Communications (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN).

In one example, the detection model 208 may be trained based on training data which may be generated in relation to execution of a process occurring in the detection system 314. The process may pertain to operation of the one or more operational component(s) 304. The data generated during operation of the one or more operational components 304 may be constantly stored in the repository 310. The data stored in the repository 310 may be utilised by the detection model 208 (as training data), for training the machine learning model 208 for detection of the unauthorized activities occurring in the environment 300. In one example, the training data may comprise training operating parameter values related to the component(s) 304. The example training data may encompass a wide range of operating conditions and scenarios experienced by the component(s) 304 over time.

Although the present example depicts the detection system 314 to be directly coupled to the component(s) 304, the detection system 314 may be coupled to other intermediate computing devices or systems, such as process control systems, data acquisition systems, or centralized monitoring platforms, which facilitates data collection, preprocessing, or distribution, without deviating from the scope of the present subject matter.

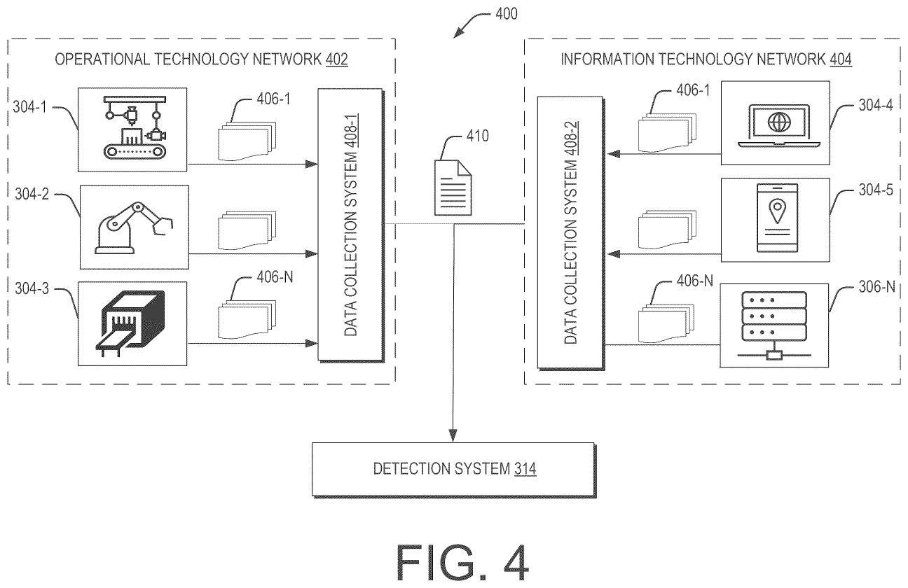

FIG. 4 illustrates components of a networked environment 400 implementing a system for detection of an unauthorized activity. The networked environment 400 pertains to the industrial control system 302, as shown in FIG. 3. In one example, the industrial control system 302 may comprise of two physical networks—an OT network 402 and an IT network 404. The OT network 402 includes programmable control systems and/or devices that may interact with physical environments or may manage devices that interact with the physical environments. Such systems and/or devices (referred as operational component(s) 304 in FIG. 3) may detect or cause a direct change through the monitoring and/or control of devices, processes, and events. On the other hand, the IT network 404 includes systems and/or devices (referred as operational component(s) 304) for orchestration of operations of the operational component(s) 304 operating in the OT network 402. The operational component(s) 304 may be deployed in any of multiple architectural levels of the industrial control system 302.

In one example, operational data 406-1, . . . 406-N (collectively referred as operational data 406), from the one or more operational component(s) 304 may be retrieved and stored in a data collection unit, such as a data collection system 408 (shown as data collection system 408-1 and 408-2 in FIG. 4). The data collection system may be implemented as a dedicated processor, a shared processor, or a plurality of individual processors, some of which may be shared. Among other capabilities, the processor may fetch and execute computer-readable instructions, including instructions, stored in a machine-readable storage medium. The machine-readable storage medium may include non-transitory computer-readable medium including, for example, volatile memory such as RAM (Random Access Memory), or non-volatile memory such as EPROM (Erasable Programmable Read Only Memory), flash memory, and the like.

Continuing further, the operational data 406 may comprise data about one or more operating parameters observed for the operational component(s) 304 over a period of time. The one or more operating parameters may reflect the operational history or current conditions of the one or more operational component(s) 304. The one or more operational component(s) 304 may be prone to vulnerabilities. Such vulnerabilities may be difficult to identify since vulnerabilities are often found when problems arise. The operational components 304 may be operating with numerous unknown vulnerabilities and may be unknown to the administrator associated with the enterprise, and in turn the detection system 314. Sometimes, the vulnerabilities may be unintentional such as unnecessary open ports and services which may have resulted in non-conforming operating parameters or may be intentional due to an attacker manipulating operations of the operational component(s) 304. Therefore, it may be crucial to identify vulnerabilities and threats to the industrial control system for determining a likelihood of threat event(s) resulting in adverse impacts, considering characteristics of threat sources that may initiate such events. The overall likelihood of an unauthorized activity is a combination of the likelihood that the activity may occur (for example, due to human error) or be initiated by an adversary, and the likelihood that such an initiation and/or occurrence results in an adverse impact.

Continuing further, any vulnerability within the OT network 402 and the IT network 404 may result in a direct impact or an indirect impact to the detection system 314 depending on whether the vulnerability is related with a direct manipulation of any operational component 304 or to a process wherein the operational component 304 may be part of. The direct impact may occur when control or monitoring functions of the operational components 304 have been manipulated. Examples may include, but are not limited to, a malware reconfigured to an operational component 304 such that the operational component 304 sends unwanted commands to the actuators controlling the operational component(s) 304 or the related process. Also, malicious commands may be sent to such operational component(s) 304 to function abnormally.

On the other hand, an indirect impact may imply that an attacker manipulates the component 304 in such a way that the impact does not immediately disturb the control or monitoring of the component 304 but may result in a fault or a vulnerability at a later stage. For example, an attacker may manipulate an actuator in a way to cause a mechanical failure in the future, without immediately impacting performance. Another example may be if an attacker compromises a preventive maintenance subsystem in the detection system 314 which may eventually cause physical sensors or actuators to operate in an unintended manner. While both examples of indirect impacts do not immediately cause damage to the physical environment, they may cause an impact in the future if critical control or sensing functions cannot be performed due to a component failure and may be flagged as an unauthorized activity over a period of time based on various traits and characteristics.

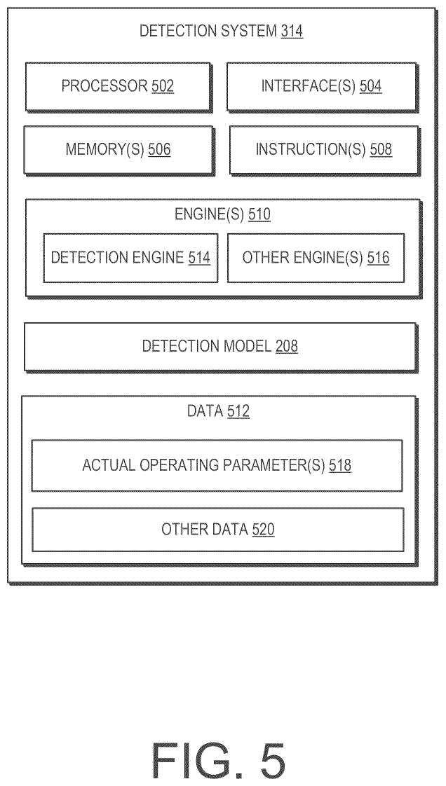

Returning to the present example, the operational data 406 of the operational component(s) 304 may be sent as data 410 to a detection system, such as the detection system 314. The detection system 314 analyzes the data 410 to indicate whether a target activity pertaining to the operational component(s) 304 is a valid activity or an unauthorized activity, as explained in conjunction to FIG. 5.

FIG. 5 illustrates components of a detection system, such as the detection system 314, as per an example. The detection system 314 (hereinafter referred as system 314) includes a processor 502, interface(s) 504, and memory(s) 506. The processor 502 may be implemented as microprocessors, microcomputers, microcontrollers, digital signal processors, central processing units, state machines, logic circuitries, and/or other devices that manipulate signals based on operational instructions. The interface(s) 504 may allow the connection or coupling of the system 314 with one or more other devices, through a wired (e.g., Local Area Network, i.e., LAN) connection or through a wireless connection (e.g., Bluetooth®, Wi-Fi). The interface(s) 504 may also enable intercommunication between different logical as well as hardware components of the system 314. The interface(s) 504 may also enable the system 314 to communicate with other entities, such as a data repository, or other devices or systems (not shown in the figures) which may be present within an industrial control system, such as the detection system 314 as depicted in FIG. 3.

The memory(s) 506 may be a computer-readable medium, examples of which include volatile memory (e.g., RAM), and/or non-volatile memory (e.g., Erasable Programmable read-only memory, i.e., EPROM, flash memory, etc.). The memory(s) 506 may be an external memory, or internal memory, such as a flash drive, a compact disk drive, an external hard disk drive, or the like. The memory(s) 506 may further include data which either may be utilized or generated during the operation of the system 314.

The system 314 may further include instructions 508, engine(s) 510 and data 512. In an example, the instructions 508 are fetched from the memory 506 and executed by the processor 502 included within the system 314. The engine(s) 510 may be implemented as a combination of hardware and programming, for example, programmable instructions to implement a variety of functionalities of the engine(s) 510. In examples described herein, such combinations of hardware and programming may be implemented in several different ways. For example, the programming for the engine(s) 510 may be executable instructions. Such instructions may be stored on a non-transitory machine-readable storage medium which may be coupled either directly with the system 314 or indirectly (for example, through networked means). In an example, the engine(s) 510 may include a processing resource, for example, either a single processor or a combination of multiple processors, to execute such instructions. In the present examples, the non-transitory machine-readable storage medium may store instructions that, when executed by the processing resource, implement engine(s) 510. In other examples, the engine(s) 510 may be implemented as electronic circuitry. In one example, the engine(s) 510 may be implemented through a machine-learning model that implements machine-learning techniques, statistical techniques, or probabilistic techniques. Examples of such techniques may include expert systems, support vector machines (SVM), neural networks, or the like.

The engine(s) 510 includes a detection engine 514, and other engine(s) 516. The other engine(s) 516 may further implement functionalities that supplement functions performed by the system 314 or any of the engine(s) 510. The data 512, on the other hand, includes data that is either stored or generated as a result of functions implemented by any of the engine(s) 510 or the system 314. It may be further noted that information stored and available in data 512 may be utilized by the engine(s) 510 for performing various functions to be implemented by the system 314. In an example, data 512 may include an actual operating parameter(s) 518 and other data 520. It may be noted that such examples of the various functional blocks as depicted in FIG. 5 are indicative. The present approaches may be applicable to other examples without deviating from the scope of the present subject matter.

The system 314 may further include a detection model, such as detection model 208. The system 314 may detect an unauthorized activity in the detection system 314, using the trained detection model 208.

The operation of the system 314 is explained in conjunction with the environments 300 and 400, as depicted in FIGS. 3-4. The system 314 may initially retrieve actual operational data from the data collection system 408. As explained in relation to FIG. 3, the actual operational data is collected from one or more operational components 304 and stored in the data collection system 408. In an example, the actual operational data include values corresponding to actual operating parameters of corresponding to an operational component 304 undergoing a target activity.

In operation, the actual operating parameter(s) 518 of an operational component, such as the operational component 304 is obtained. In an example, the actual operating parameters 518 includes values corresponding to operating parameters of an operational component (such as operational component 304) operating with respect to the target activity. The operational component(s) 304 are installed within the detection system 314 and may be under monitoring. In one example, performance indicator(s) may be associated with each of the actual operating parameter(s) 518 and may indicate values corresponding to various performance metric which may be achieved during the target activity by the operational component(s) 304 if the values of the actual operating parameter(s) 518 are applied to or maintained for the target activity. The values corresponding to various performance metrics achieved by the operational component(s) 304 during the target activity may be predefined, for example, by an administrator associated with the detection system 314.

Returning to the present example, the actual operating parameter(s) 518 may be retrieved in response to a command, or the system 314 may be configured to retrieve the actual operating parameters 518 from a data collection unit, such as the data collection system 408 (as shown in FIG. 4) at predefined intervals or specified time instants. For example, the actual operating parameter(s) 518 may be obtained from sources comprising user activity logs, network traffic logs, security management logs, change management logs, event and alarm histories, maintenance logs, or combinations thereof, associated with the detection system 314. In one example, the operational component(s) 304 may be a sensor, actuator, controller, terminal units, programmable logic controllers (PLCs), distributed control systems (DCS), security system, machine interfaces, or combination thereof, operating within the detection system 314.

Once the actual operating parameter(s) 518 are obtained, the detection engine 514 may process the same to determine whether the target activity to which the actual operating parameter(s) 518 pertain to, is a valid activity. Once the determination is made, the detection engine 514 may indicate that the target activity is one of a valid activity or an unauthorized activity. In accordance with one example of the present subject matter, on determining that the target activity is an unauthorized activity, the detection engine 514 may determine a type of the operational component, which the target activity pertains to, as per below table 1:

TABLE 1

| Type of | Actual operating |
|---|---|
| component | parameter(s) |
| Component 304-1 | 23 |
| Component 304-2 | 45 |
| Component 304-3 | 76 |

Based on a criticality factor associated with the type of the operational component, the detection engine 514 may annotate a risk factor to the target activity. In the present context, the criticality factor may refer to a measure indicating the relative importance or a potential impact of the one or more operational components 304 operating within the detection system 314. The criticality factor may be used to prioritize resources, attention, and risk management efforts based on how crucial an element is to overall operations, safety, or business continuity in the detection system 314. Also, the criticality factor may be related with the severity of potential consequences if the one or more operational components 304 fail, and the likelihood of failure associated thereof. In one example, the criticality factor may be predefined with respect to the detection system 314 or may be defined by an administrator associated with the detection system 314, and may help identify vital operational component(s) 304, allocate security measures effectively, and develop targeted contingency plans.

Further, the risk factor may be indicative of an impact cause by failure of the operational component, as per the below table 2:

TABLE 2

| Type of | Criticality Factor | Risk |
|---|---|---|
| Component | (1-10) | Factor |
| Component 304-1 | 10 | High |
| Component 304-2 | 2 | Low |
| Component 304-3 | 6 | Medium |

The actual operational data may also comprise a plurality of identifiers linking the operational component to the corresponding actual operating parameter(s) 518. On determination of the unauthorized activity, the detection engine 514 may indicate the identifier of the operational component 304 which the target activity pertains to. The indication may be one of a visual alert, an audio alert, and combinations thereof, without deviating from the present subject matter. The concerned personnel may then take the prescribed remedial measures for remedying the situation and curb the occurrence of the unauthorized activity. For taking the prescribed remedial measures, the detection engine 514 may retrieve a mapping (which may be stored in the memory 506), associating the plurality of risk factors with corresponding remedial measures. Based on the annotated risk factor, the processor 502 may generate instructions 508, to cause the processor 502 to execute a set of prescribed remedial instructions which when executed may implement the corresponding remedial measure. In one example, the remedial measures may pertain to specific actions and/or interventions that may be taken in response to detection of the unauthorized activities within the detection system 314, as per below table 3,

TABLE 3

| Type of | Criticality Factor | Risk | Remedial |
|---|---|---|---|
| Component | (1-10) | Factor | Measure |
| Component 304-1 | 10 | High | xxx |
| Component 304-2 | 2 | Low | abc |
| Component 304-3 | 6 | Medium | suv |

Such measures may be implemented to mitigate risk(s), prevent further damage(s), and restore normal operation(s) in the detection system 314. The system 314 may be implemented to associate a plurality of risk factors with associated remedial measures. When an unauthorized activity is detected and the corresponding risk factor is determined, the system 314 may retrieve the prescribed remedial measure stored in the memory 506. In one example, such remedial measures may include actions such as isolating affected operational component(s) 304, initiating backup systems, alerting security personnel, triggering automated defence mechanisms, or initiating predefined incident response protocols. The specific nature of the remedial measure may be tailored to the type of unauthorized activity, the criticality of the affected operational component 304, and the overall risk assessment. Such an approach may allow for a rapid, targeted response to security incidents, minimizing potential damage and ensuring the continued safe operation of the detection system 314.

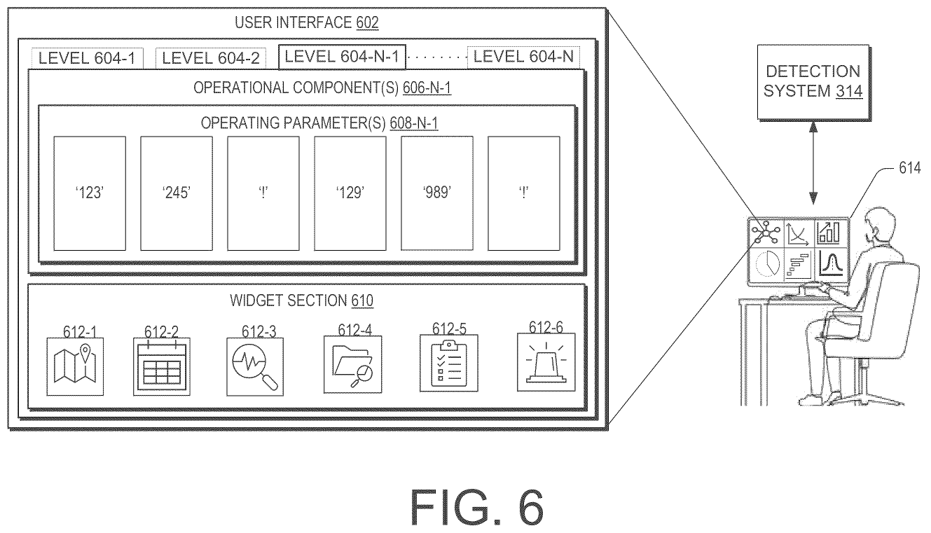

An example implementation of user interface is depicted in FIG. 6. FIG. 6 illustrates a networked industrial environment 600 comprising a detection system, such as detection system 314 connected to a workstation, such as workstation 614 through a network (not shown in FIG. 6). The workstation 614 includes a display interface presenting a user interface 602 to the operator, who may be working at the workstation 614.

The user interface 602 comprises one or more informational sections and sub-sections. The informational sections are to provide information pertaining to different data elements as discussed in conjunction with the preceding figures. The user interface 602 may include a visual representation or various blocks comprising selectable options to select one or more levels 604-1, 604-2, . . . , 604-N (collectively referred as level(s) 604). Each level 604 comprising information pertaining to operational component(s) 606. The information about the operational component 606 may further comprise one or more operating parameter(s) 608 associated with the operational component 606.

In one example, level(s) 604 are representative of the various architectural levels of an industrial control system, such as the industrial control system 302 as shown in FIG. 3. In one example, the detection system 314 comprises a plurality of level(s) 604, wherein one or more of operational components, such as the operational component(s) 606 may be deployed and operating. The one or more operational components 606 may be operating in an operational technology (OT) network or an information technology (IT) network. For example, within the detection system 314, two physical networks may be operating—the OT network 402 and the IT network 404. Each of the operational component(s) 606 may be associated with an operating parameter 608 with corresponding values. The corresponding values may pertain to actual operating parameters of the operational component(s) 606. In an example, the actual operating parameters includes values corresponding to operating parameters of an operational component (such as operational component 606) operating with respect to a target activity. The operational component 606 is installed within the detection system 314 and is under monitoring. In one example, performance indicator(s) may be associated with each of the operating parameter(s) 608 and may indicate values corresponding to various performance metric which may be achieved during the target activity by the operational component 606 if the values of the actual operating parameter(s) are applied to or maintained for the target activity.

In one example, the operating parameter(s) 608 may be obtained from sources comprising user activity logs, network traffic logs, security management logs, change management logs, event and alarm histories, maintenance logs, or combinations thereof, associated with the detection system 314. In one example, the operational component(s) 606 may be a sensor, actuator, controller, terminal units, programmable logic controllers (PLCs), distributed control systems (DCS), security system, machine interfaces, or combination thereof, operating within the detection system 314.

In one example, the user interface 602 comprises a widget section 610. The widget section 610 may comprise one or more informational sections 612-1, 612-2, . . . ,612-6. The one or more informational sections 612-1, 612-2, . . . ,612-6 may be selected by the user associated with the workstation 614. For example, the widget 612-1 may be a location tracker widget. Within the detection system 314, the operational component(s) 606 may be deployed and the location tracker widget 612-1 may indicate the location of the operational component(s) 606 (both geographical and virtual). In one example, location tracking request may be received in response to a command initiated from the workstation 614.

Continuing further, the widget 612-2 may be a time period tracking widget. For example, each operational component 606 may have a history of performance values associated therewith. The time period tracking widget 612-2 may be selected in response to a command initiated from the workstation 614 for determining historical operating parameters corresponding to each of the operational component(s) 606. The historical operating parameters may help understand a pattern and/or trend with respect to the operational component(s) 606. The historical operating parameters may comprise performance values of the operational component(s) during normal operating conditions, peak operating conditions, faulty operating conditions, and more.

For example, the historical operating parameters may comprise data about performance values of the operational component(s) 606 in an untampered process. However, in case of tampering of any activity in relation to a process wherein the operational component(s) 606 may be operating, there may be a variation and/or deviation of the operating parameter(s) 608. The variation and/or deviation of the real-time operating parameter(s) 608 versus the historical operating parameters may be analysed by an analysis widget 612-3. The analysis widget 612-3 may be selected by the user associated with the workstation 614 to understand similarities or differences between the real-time operating parameter(s) 608 being depicted on the screen versus the historical parameters of the operational component(s) 606.

Further, the widget 612-4 may be a data search widget 612-4. The data search widget 612-4 may be selected to search data regarding authorised working parameters of the operational component(s) 606. For example, each of the operational component(s) may have one or more working parameter(s) associated therewith. The working parameter(s) may be indicative of parameter(s) set by the vendor of the operational component(s). For example, an industry grade equipment may be manufactured to operate in a certain range. Therefore, the specifications of each of the operational component(s) 606 may be stored in a database associated the detection system 314 and searched through the data search widget 612-4, in response to a command initiated from the workstation 614.

In one example, the widget 612-5 may be a checklist widget. For example, each of the operational component(s) 606 may have one or more operating parameter(s) 608 associated therewith. At any instance, one or more operating parameter(s) 608 of the total operating parameter(s) 608 may be depicting a normal performance value (for example, as per norms set by the administrator), while one or more operating parameter(s) 608 may depict faulty performance values. Although, the same may not indicate occurrence of manipulations to the operational component(s) 606, however, the occurrence of faulty performance values may alert the user.

For determining that the faulty performance values are associated with manipulated operations, the detection system 314 may process the operating parameter(s) 608 to determine whether a target activity to which the operating parameter(s) 608 pertain to, is a valid activity. The determination of the same may be based on a trained detection model, such as the trained detection model 208 which may be trained using training operational data comprising training operating parameter(s). The training operating parameter(s) may pertain to a plurality of valid activities occurring in an untampered process, executing within the detection system 314. Once the determination is made, the detection system 314, may indicate that the target activity is one of a valid activity or an unauthorized activity. On determining that the target activity is an unauthorized activity, the detection system 314 may determine a type of the operational component, to which the target activity pertains to.

On determination of the unauthorized activity, an alert may be generated by the alert widget 612-6. The alert widget 612-6 may indicate identifier(s) of the operational component 606 to which the target activity pertains to. The indication may be one of a visual alert, an audio alert, and combinations thereof, without deviating from the present subject matter. The user associated with the workstation 614 may then take an appropriate measure for remedying the situation and curb the occurrence of the unauthorized activity.

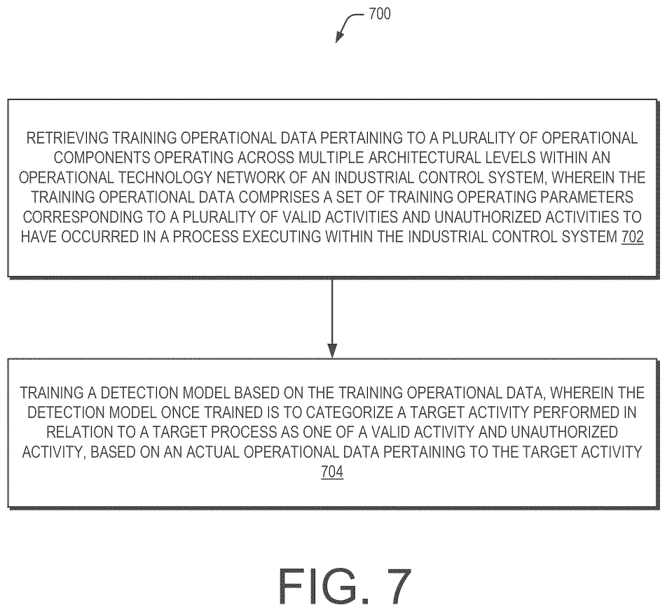

FIG. 7 illustrates example method 700 for training a detection model, in accordance with examples of the present subject matter. The order in which the above-mentioned method is described is not intended to be construed as a limitation, and some of the described method blocks may be combined in a different order to implement the methods, or alternative methods.

Furthermore, the above-mentioned method 700 may be implemented in suitable hardware, computer-readable instructions, or combination thereof. The steps of such methods may be performed by either a system under the instruction of machine executable instructions stored on a non-transitory computer readable medium or by dedicated hardware circuits, microcontrollers, or logic circuits. For example, the method may be performed by a training system, such as system 202. In an implementation, the method may be performed under an “as a service” delivery model, where the system 202, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

In an example, the method 700 may be implemented by the system 202 for training the detection model 208 based on a training data, such as training data 214.

At block 702, training data including a training operational data 216 is obtained. In an example, the training operational data 216 comprises data pertaining to training operating parameters 218. For example, the system 202 may obtain the training data 214 from the repository 212 and data included in the training data 214 may be further stored as training data 214 in the system 202. The training data 214 may pertain to data about a plurality of operational components operating across multiple architectural levels of an industrial control system, such as the detection system 314.

In an example, the detection model 208 is trained based on training data pertaining to a plurality of operating parameters. In one example, the plurality of operating parameters pertains to a plurality of operational components operating across multiple architectural levels within an operational technology network of an industrial control system. In an example, the system 202 may obtain the training data 214 at one time, or in batches, from the repository 212.

At block 704, the detection model may be trained. For example, the system 202 may obtain the training data 214 from the repository 212 and the data included in the training data 214 may further be stored as training operational data 216 comprising a set of training operating parameter(s) 218. The of training operating parameters 218 may correspond to a plurality of valid activities and unauthorized activities to have occurred in a process executing within the industrial control system. The training operational data 216 may comprise, but is not limited to, different loading stages, peak loads experienced, one or more failure observed during operation, performant operation, or combination therefore, of the plurality of operational components. In one example, the training operational data 216 may be obtained from, but are not limited to, user activity logs, network traffic logs, security management logs, change management logs, event and alarm histories, maintenance logs, or combinations thereof.

The detection model 208 may be trained to categorize a target activity performed in relation to a target process as one of a valid activity and unauthorized activity. The determination of the target activity regarding whether the target activity is a valid activity, or an unauthorized activity may be based on an actual operational data pertaining to the target activity. In one example, the detection model 208 may also be trained based on additional operating parameter(s) received from an administrator. For example, the detection model 208 may be trained over a period of time. For instance, actual operational data of the plurality of operational components may be continuously monitored to ascertain whether the operational component(s) continue to operate in a performant manner. The detection model 208 is trained to indicate when the operational data exceeds a threshold value prescribed in predefined rules configured for the plurality of operational components. An alert may be generated, and further actions may be required for addressing the conditions that may have resulted in generation of such alerts. Herein, the target activity and the target process may correspond to all activities and processes being executed within the industrial control system.

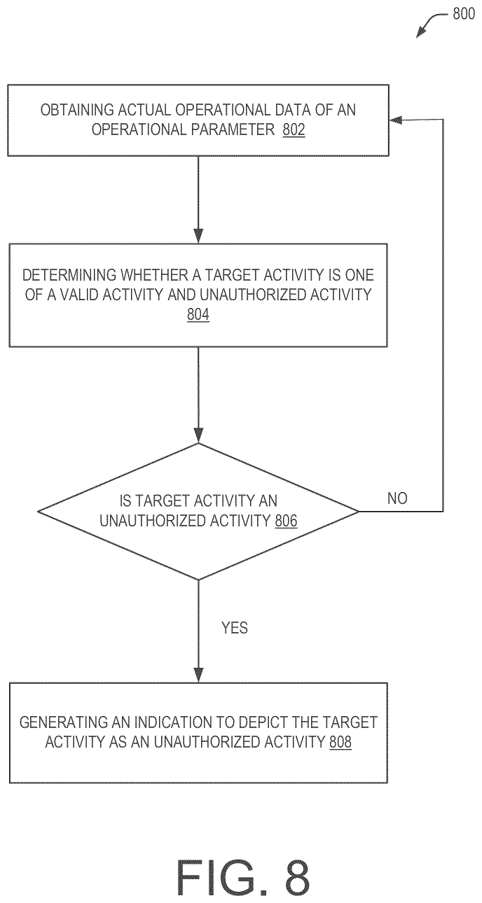

FIG. 8 illustrates a method 800 for detection of an unauthorized activity in an industrial control system, as per an example. The order in which the above-mentioned methods are described is not intended to be construed as a limitation, and some of the described method blocks may be combined in a different order to implement the method, or an alternative method.

In an example, the above-mentioned methods may be implemented by a detection engine (such as detection engine 514) of the detection system 314. The above-mentioned methods are explained from the perspective of a target activity in relation to a target process occurring within the industrial control system. Although the present explanation is provided in relation to detection of an unauthorized activity in a target activity occurring in the industrial control system, these approaches may also be applicable for a greater number of target activities. Such implementations too would fall within the scope of the present subject matter.

At block 802, actual operational data is obtained. The actual operational data may correspond to one or more operational components operating within the detection system 314. For example, the detection system 314 may comprise of two physical networks—the OT network 402 and the IT network 404. The operational component, such as the operational component 304 may be operating within one of the OT network 402 and the IT network 404. The operational component 304 may be deployed and operating in any of the multiple architectural levels of the detection system 314. Each of the operational component(s) 304 may have a corresponding operational data which may be associated with operating parameter(s).

Further, the actual operating parameter(s) 518 of an operational component 304 may be obtained. In an example, the actual operating parameters 518 includes values corresponding to operating parameters of an operational component (such as operational component 304) operating with respect to a target activity. The operational component 304 is installed within the detection system 314 and is under monitoring. In one example, performance indicator(s) may be associated with each of the actual operating parameter(s) 518 and may indicate values corresponding to various performance metric which may be achieved during the target activity by the operational component 304 if the values of the actual operating parameter(s) 518 are applied to or maintained for the target activity.

For example, the actual operating parameter(s) 518 may be obtained from sources comprising user activity logs, network traffic logs, security management logs, change management logs, event and alarm histories, maintenance logs, or combinations thereof, associated with the detection system 314. In one example, the operational component(s) 304 may be a sensor, actuator, controller, terminal units, programmable logic controllers (PLCs), distributed control systems (DCS), security system, machine interfaces, or combination thereof, operating within the detection system 314.

At block 804, whether the target activity is one of a valid activity or an unauthorized activity may be determined. In one example, once the actual operating parameter(s) 518 are obtained, the detection engine 514 may process the same to determine whether the target activity to which the actual operating parameter(s) 518 pertain to, is a valid activity. The determination of the same may be based on a trained detection model, such as the trained detection model 208 trained using training operational data comprising training operating parameter(s). The training operating parameter(s) may pertain to a plurality of valid activities occurring in an untampered process, executing within the detection system 314. For example, the detection engine 514 may indicate that actual operational data pertaining to a target activity is one of a valid activity or an unauthorized activity. For example, the one or more operational components 304 may be prone to vulnerabilities. Such vulnerabilities may be difficult to identify since vulnerabilities are often found when problems arise. The operational components 304 may be operating with numerous unknown vulnerabilities and may be unknown to the administrator associated with the detection system 314. Sometimes, the vulnerabilities may be unintentional such as unnecessary open ports and services which may have resulted in non-conforming operating parameters or may be intentional due to an attacker manipulating operations of the operational component(s) 304.

Continuing further, any vulnerability within the OT network 402 and the IT network 404 may result in a direct impact or an indirect impact to the detection system 314 depending on whether the vulnerability is related with a direct manipulation of any operational component 304 or to a process wherein the operational component 304 may be part of. The direct impact may occur when control or monitoring functions of the operational components 304 have been manipulated. Examples may include, but are not limited to, a malware reconfigured to an operational component 304 such that the operational component 304 sends unwanted commands to the actuators controlling the operational component(s) 304 or the related process. Also, malicious commands may be sent to such operational component(s) 304 to function abnormally.

On the other hand, an indirect impact may imply that an attacker manipulates the component 304 in such a way that the impact does not immediately disturb the control or monitoring of the component 304, but may result in a fault or a vulnerability at a later stage. For example, an attacker may manipulate an actuator in a way to cause a mechanical failure in the future, without immediately impacting performance. Another example may be if an attacker compromises a preventive maintenance subsystem in the detection system 314 which may eventually cause physical sensors or actuators to operate in an unintended manner. While both examples of indirect impacts do not immediately cause damage to the physical environment, they may cause an impact in the future if critical control or sensing functions cannot be performed due to a component failure, and may be flagged as an unauthorized activity over a period of time based on various traits and characteristics. The detection system 314 may be implemented to categorize the incoming data (for example, the actual operational data) of the one or more operational component(s) 304 pertinent to the target activity, as one of the valid activity data and the unauthorized data.

At block 806, categorized data pertinent to the target activity is compared. In one example, upon determination that the target activity is an unauthorized activity, the method proceeds to block 802, otherwise the method proceeds to block 802.

At block 808, an indication is generated. On determination of the unauthorized activity, the detection engine 514 may generate an indication. The indication may be one of a visual alert, an audio alert, and combinations thereof, without deviating from the present subject matter. The concerned personnel may then take an appropriate measure for remedying the situation and curb the occurrence of the unauthorized activity. Post generation of the indication that the target activity is an unauthorized activity, appropriate remedial measures may be undertaken. Such measures may be implemented to mitigate risk(s), prevent further damage(s), and restore normal operation(s) in the detection system 314. In one example, such remedial measures may include actions such as isolating affected operational component(s) 304, initiating backup systems, alerting security personnel, triggering automated defence mechanisms, or initiating predefined incident response protocols. The specific nature of the remedial measure may be tailored to the type of unauthorized activity, the criticality of the affected operational component 304, and the overall risk assessment. Such an approach may allow for a rapid, targeted response to security incidents, minimizing potential damage and ensuring the continued safe operation of the detection system 314.

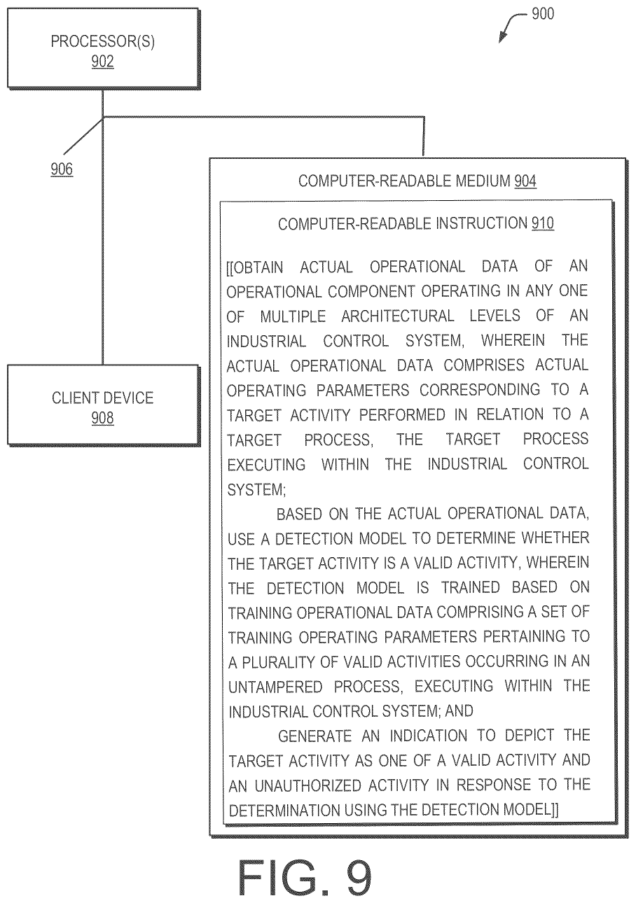

FIG. 9 illustrates a computing environment 900 implementing a non-transitory computer readable medium for detecting an unauthorized activity, in response to a set of operating parameters values observed in relation to an operational component over a period of time. In an example, the computing environment 900 includes processor(s) 902 communicatively coupled to a non-transitory computer readable medium 904 through a communication link 906. In an example implementation, the computing environment 900 may be for example, the system 202. In an example, the processor(s) 902 may have one or more processing resources for fetching and executing computer-readable instructions from the non-transitory computer readable medium 904. The processor(s) 902 and the non-transitory computer readable medium 904 may be implemented, for example, in system 202 (as has been described in conjunction with the preceding figures).

The non-transitory computer readable medium 904 may be, for example, an internal memory device or an external memory device. In an example implementation, the communication link 906 may be a network communication link. The processor(s) 902 and the non-transitory computer readable medium 904 may also be communicatively coupled to a computing device 908 over the network.

In an example implementation, the non-transitory computer readable medium 904 includes a set of computer readable instructions 910 (referred to as instructions 910) which may be accessed by the processor(s) 902 through the communication link 906. Referring to FIG. 9, in an example, the non-transitory computer readable medium 904 includes instructions 910 that cause the processor(s) 902 to perform operations for detecting an unauthorized activity, in relation to an operational component, such as the operational component 304 (as shown in FIGS. 3-4). The instructions 910 may be executed to obtain actual operational data of an operational component operating in any one of multiple architectural levels of an industrial control system. Herein, the actual operational data may comprise actual operating parameters corresponding to a target activity. The actual operating parameters may be obtained from sources comprising user activity logs, network traffic logs, security management logs, change management logs, event and alarm histories, and maintenance logs, pertaining to one or more operational components operating in the multiple architectural levels of the industrial control system.

Further, the target activity may be performed in relation to a target process, executing within the industrial control system. In one example, the operational component may be a control system, or a device deployed within one of the multiple architectural levels of the industrial control system. The operational components may operate within the industrial control system. The values of these operating parameters may be obtained directly from sensors on the operational components or from an intermediate data storage system where such information is collected and stored.

Once the obtained, the instructions 910 may cause the processor(s) 902 to use a detection model, such as a detection model, to perform one of two operations. For example, the detection model may be used to determine whether the target activity is a valid activity. The determination of whether the target activity is a valid activity is based on the trained detection model. In one example, the detection model is trained based on training data comprising a set of training operating parameters. The training operating parameters may pertain to a plurality of valid activities occurring in an untampered process, executing within the industrial control system.

In an example, the instructions 910 may cause the processor(s) 902 to whether the target activity is a valid activity, the instructions 114 may be executed to generate an indication to depict the target activity is one of a valid activity and an unauthorized activity, in response to determination using the detection model.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

1. A system comprising:
a processor; and
a machine-readable storage medium comprising instructions executable by the processor to:
obtain actual operational data of an operational component operating in any one of multiple architectural levels of an industrial control system, wherein the actual operational data comprises actual operating parameters corresponding to a target activity performed in relation to a target process, the target process executing within the industrial control system;
based on the actual operational data, use a detection model to determine whether the target activity is a valid activity, wherein the detection model is trained based on training data comprising a set of training operating parameters pertaining to a plurality of valid activities occurring in an untampered process, executing within the industrial control system; and
generate an indication to depict the target activity as one of a valid activity and an unauthorized activity in response to the determination using the detection model.

2. The system as claimed in claim 1, wherein the operational component is one of a control system and a device deployed within one of the multiple architectural levels of the industrial control system.

3. The system as claimed in claim 1, wherein the instructions, on determining the target activity is an unauthorized activity, are executable to further:
determine a type of the operational component, to which the target activity pertains to; and
based on a criticality factor associated with the type of operational component, annotate a risk factor to the target activity, wherein the risk factor is indicative of an impact caused by failure of the operational component.

4. The system as claimed in claim 3, wherein the instructions are to further:
retrieve a mapping, associating a plurality of risk factors with prescribed remedial measures; and
based on the annotated risk factor, cause to execute a set of remedial instructions which when executed implement associated remedial measure.

5. The system as claimed in claim 1, the operational components are to operate within an operational technology network of the industrial control system.

6. The system as claimed in claim 1, wherein the actual operational data is obtained in real-time or in batches.

7. The system as claimed in claim 1, wherein the actual operating parameters are obtained from sources comprising user activity logs, network traffic logs, security management logs, change management logs, event and alarm histories, maintenance logs, or combinations thereof.

8. The system as claimed in claim 1, wherein the actual operational data comprises an identifier linking the operational component to the actual operating parameters.

9. The system as claimed in claim 8, wherein the indication depicts the identifier of the one of the control systems and devices to which the target activity pertains to.

10. The system as claimed in claim 1, wherein the indication is a visual alert, an audio alert, or combination thereof.

11. The system as claimed in claim 1, wherein the operational component comprises a sensor, actuator, controller, terminal units, programmable logic controllers (PLCs), distributed control systems (DCS), security system, machine interfaces, or combination thereof.

12. A method comprising:
retrieving training data pertaining to a plurality of operational components operating across multiple architectural levels within an operational technology network of an industrial control system, wherein the training data comprises a set of training operating parameters corresponding to a plurality of valid activities and unauthorized activities to have occurred in a process executing within the industrial control system; and
training a detection model based on the training data, wherein the detection model once trained is to categorize a target activity performed in relation to a target process as one of a valid activity and unauthorized activity, based on an actual operational data pertaining to the target activity.

13. The method as claimed in claim 12, wherein the training data comprises data corresponding to different loading stages, peak loads experienced, one or more failure observed during operation, performant operation, or combination therefore, of the plurality of operational components.

14. The method as claimed in claim 12, wherein the training data is obtained from sources comprising user activity logs, network traffic logs, security management logs, change management logs, event and alarm histories, maintenance logs, or combinations thereof.

15. The method as claimed in claim 12, further comprising:
receiving additional operating parameters from an administrator of the industrial control system; and
further training the detection model based on the additional operating parameters.

16. A non-transitory computer-readable medium comprising instructions, the instructions being executable by a processing resource of a system, to:
obtain actual operational data pertaining to an operational component operating in any one of multiple architectural levels of an industrial control system, wherein the actual operational data comprises actual operating parameters corresponding to a target activity performed in relation to a target process executing within the industrial control system;
based on the actual operational data, use a detection model to determine whether the target activity is a valid activity, wherein the detection model is trained based on training data comprises a set of training operating parameters pertaining to a plurality of valid activities occurring in an untampered process executing within the industrial control system; and
cause to generate an indication to depict the target activity as one of a valid activity and an unauthorized activity in response to the determination using the detection model.

17. The non-transitory computer-readable medium as claimed in claim 16, wherein the instructions, on determining the target activity is an unauthorized activity, are executable to further:
determine a type of the operational component, to which the target activity pertains to; and
based on a criticality factor associated with the type of operational component, determine a risk factor to the target activity, wherein the risk factor is indicative of an impact caused by failure of the operational component.

18. The non-transitory computer-readable medium as claimed in claim 16, the operational components are to operate within an operational technology network and an information technology network of the industrial control system.

19. The non-transitory computer-readable medium as claimed in claim 16, wherein the actual operating parameters are obtained from sources comprising user activity logs, network traffic logs, security management logs, change management logs, event and alarm histories, maintenance logs, or combinations thereof.

20. The non-transitory computer-readable medium as claimed in claim 16, wherein the actual operational data comprises an identifier linking the operational component to the actual operating parameters.
